(19) United States
(12) Patent Application Publication
(10) Pub. No.: US 2006/0292325 A1
(43) Pub. Date: Dec. 28, 2006

(54) Release sheet and adhesive body

(75) Inventors: Koutarou Nozawa, Yokkaichi-Shi (JP); Maki Saito, Yokohama-shi (JP); Etsushi Akashige, Yokkaichi-shi (JP); Osamu Nishizawa, Yokkaichi-shi (JP); Motohiro Seki, Yokkaichi-shi (JP)

Correspondence Address: EDWARDS & ANGELL, LLP, P.O. BOX 55874, BOSTON, MA, 02205, US

(73) Assignee: Mitsubishi Polyester Film Corporation

(21) Appl. No.: 11/369,642

(22) Filed: Mar. 6, 2006

Related U.S. Application Data
(63) Continuation-in-part of application No. PCT/JP03/11469, filed on Sep. 9, 2003.

(51) Int. Cl. B32B 33/00

(52) U.S. Cl. 428/40.1

(57) ABSTRACT

A release sheet comprising a release substrate and a release layer which comprises cross-linked polyolefin, is formed at least one side of said release substrate, and has from 10 to 300 mN/cm of release force to an adhesive layer formed from a 2 packs type acryl-based adhesive agent. The said release sheet has an excellent heat resistance, solvent resistance, adhesion between a release layer and a release substrate and capability of direct transfer coating of an adhesive layer on a release layer.

### CROSS REFERENCE TO RELATED APPLICATION

This is a continuation-in-part of application of international application PCT/JP03/11469, filed Sep. 9, 2003 which designated the US. The entire contents of this application are incorporated herein by reference.

### BACKGROUND OF THE INVENTION

The present invention relates to a release sheet having an excellent heat resistance, solvent resistance, adhesion between a release layer and a release substrate and capability of direct transfer coating of an adhesive layer on a release layer. Further, the present invention relates to an adhesive body comprising an adhesive layer formed on a release layer.

Release films have been extensively used for protecting an adhesive surface or a bonding surface. Silicone-based polymers comprising siloxane-units Materials have been generally used to form a release surface of a release film. However, the silicone-based release agents caused such problems that since siloxane-based low molecular weight compound present in the single-based release agents are gas-generated therefrom, they are oxidized in air to form oxide materials and are stick, especially in case of using it for the precise application fields such as electronic equipments. Therefore, there is a demand for a new release film having the same releasability as silicone-based release film has and having no silicone-based release agent. For example, the rate of the development of performance and memory density of hard disk devices is remarkably high and this tendency will continue in the coming years. According to the further improvement of the performance and memory density of hard disk devices, it is suggested that the deposition of fine dusts of silicone compound described above causes some troubles for an ability to read and write of a hard disk device.

In order to apply such applications, there have been proposed release agents which are reduced in surface energy by using halogen compounds such as fluorides. These release layers are described in several published documents such as Japanese Patent Application Laid-Open (KOKAI) Nos. S55-165925, H1-198349, H4-246532, H4-270649, H4-290746, 2001-129940, 2001-138338, 2000-263714 and 2001-129940. However, these release layers show a heavy release force comparing to conventional silicone-based ones and are inappropriate for the trend of using non-halogenated compounds according to the recent waste disposal requirement for the environmental load reduction.

Polyolefins or polymers having long-chain alkyl groups have been known as examples of release layer having neither silicone nor halogen elements. They are described in several published documents such as Japanese Patent Application Laid-Open (KOKAI) Nos. S54-7442, S55-69675, H5-329994, H10-183078, H11-28708 and 2000-303019. But there are some drawbacks that their release force exceeds 100 mN/cm which are classified as heavy peeling so that their applications are limited. Examples of technologies to achieve polyolefin-based release layers showing a light peeling may include technologies described in Japanese Patent Application Laid-Open (KOKAI) Nos. 2001-246697 and 2000-248237. Unfortunately, they are not suitable for process films on which organic solvent or dispersant is cast. In the case of using polyolefin, there is a problem that a release layer was adhered to an adhesive agent and peeled from the release substrate due to the insufficient of adhesion between the release layer and the release substrate when the adhesive agent is peeled from the release layer. In order to avoid this drawback, some methods have been proposed such as a bonding resin is applied between the release layer and the substrate to keep the bonding strength between a release layer and a release substrate.

A silicone-based release sheet having an elastic property, a heat resistance and a chemical resistance may be obtained by chemical cross-linking of the silicone resin applied on a release substrate. In order to obtain an adhesive body, it is possible to select a process of “direct coatin” in which an adhesive sheet which is provided an adhesive layer on an adhesive substrate is laminated to a silicone-based release sheet, or “transfer coating” in which an adhesive layer is provided by applying an adhesive agent solution on a release layer followed by heating and drying to evaporate solvent with a chemical reaction of the adhesive agent and the adhesive layer is laminated to an adhesive substrate. The transfer coating has an advantage that an adhesive body can be formed without damage against the adhesive substrate comparing to the direct coating, because an adhesive layer is provided on a release sheet and thereafter an adhesive substrate is laminated thereon. Because of this reason, transfer coating is widely used in the field of indicating labels.

However, non-silicone-based release agents have not been suitable for transfer coating because they are inferior to chemical and heat resistance or do not have a low release force. Further, adhesive sheets have been also provided by a different process for forming a release sheet comprising a release layer and a release substrate, therefore, an adhesive body is provided by laminating the adhesive sheet with a release sheet. According to these processes, an adhesive body having a low release force has not been obtained.

The object of the present invention is to provide a release sheet and an adhesive body having excellent heat and solvent resistances, excellent adhesion properties to release substrate and capable to transfer coat an adhesive layer to a release layer under the consideration of problems of prior arts.

### SUMMARY OF THE INVENTION

As a result of the present inventors' earnest studies for solving the above problems, it has been found that the above object can be readily accomplished by adopting release layers formed by chemical cross-linking of a reactive polyolefin, which substantially do not contain silicone or halogen elements and allow to form excellent release layers. The present invention has been attained on the basis of the above findings. In an aspect of the present invention, there is provided a release sheet comprising a release substrate and a release layer which comprises cross-linked polyolefin, is formed one at least one side of said release substrate, and has from 10 to 300 mN/cm of release force to an adhesive layer formed from a 2 packs type acryl-based adhesive agent.

The release agents described above preferably comprises a reactive polyolefin, a multi-functional compound having not less than 2 functional groups per molecule which is reactable with said reactive polyolefin and non-reactive polyolefin having a density of not more than 0.94 g/cm³. The reactive-polyolefin preferably has functional groups which are reactable with the multi-functional compounds in an amount of 0.01 to 5% by weight. Further, the release agents described above preferably comprise a polyolefin having functional groups which are reactable with multi-functional compounds in an amount of 0.01 to 5% by weight and having a density of not more than 0.94 g/cm³, and multi-functional compounds having not less than 2 functional groups per molecule which is reactable with said reactive polyolefin. Furthermore, the preferable functional groups in the reactive polyolefin and multi-functional compounds are individually any of functional groups selected from the group consisting of epoxy group, hydroxyl group, acid anhydride group, isocyanate group and amino group.

A thickness of the release layer constituting the release sheet of the present invention is preferably 0.03 to 5 μm. The release layer may be formed by applying a release agent solution, prepared by dissolving the release agent comprising the reactive polyolefin in organic solvent, on a release substrate and cross-linking the release agent. The release substrates constituting the release sheet of the present invention are preferably plastic films or papers, more preferably polyester film or polyolefin film.

In the present invention, an adhesive body formed by providing an adhesive layer on a release layer of a release sheet. The adhesive layer is preferably formed by transfer coating of a solution containing an adhesive agent.

### DETAILED DESCRIPTION OF THE INVENTION

The further detail of the release sheet and the adhesive body of the present invention is explained as follows. In the specification of the present invention, numerical ranges shown by “to” means that the values described before and after “to” are minimum limit and maximum limit of the ranges respectively.

The first aspect of the present invention is a release sheet having a release layer on at least one side of a release substrate. The release layer comprises a cross-linked polyolefin, which is usually formed by cross-linking reaction of a release agent comprising a reactive polyolefin. Example of methods to form release layers may include cross- linking a reactive polyolefin with a compound enable to cross-linking with the reactive polyolefin or cross-linking a reactive polyolefin thereof. By using this kind of cross-linking reaction of a reactive polyolefin, a release layer having heat and chemical resistance and excellent adhesion to a release substrate may be formed. According to the present invention, there is no need to contain silicone compounds in the release layer, thereby avoiding the various problems due to the use of silicone compounds.

Materials or shapes of the release substrate of the present invention are not particularly limited, as long as the film has a function to support a release layer. A smooth film or sheet is preferred.

Examples of the film or sheet may include polyester film such as poly(ethylene terephthalate) film and poly(butylene terephthalate) film, polyolefin film such as polypropylene film and polymethylpentene film, plastic film such as polycarbonate film, metal film such as aluminum and stainless steel, papers such as glassine paper, woodfree paper, coated paper, impregnated paper and synthetic paper.

Preferred release substrates are one constituted by polyester film such as poly(ethylene terephthalate)film and poly(butylene terephthalate), plastic film such as polypropylene film or so-called dust free paper which generates only a trace amount of dust (Example thereof are described in Japanese Patent Publication (KOKOKU) No. H6-11959). When the plastic film or the dust free paper is used as the release substrate, generation of dusts, etc., can be prevented upon processing or use thereof, so that adverse influence on electronic equipments such as hard disc devices can be avoided. Further, the plastic film or the dust free paper used as the release substrate can be readily cut or punched upon further processing thereof.

In the case where plastic film is used as the release substrate, the material thereof is more preferably poly(ethylene terephthalate) film or oriented polypropylene film. These films are advantageous since the amount of dusts generated therefrom is lessened, and the amount of gases generated upon heating is also lessened.

The thickness of the substrate is not particularly limited, and preferably 10 to 200 μm, more preferably 25 to 50 μm.

A surface treatment may be applied on the surface of the release substrate. Examples may include the application of a primer resin coating and a surface activation treatment using plasma or flame plasma.

The release layer constituting the release sheet of the present invention is a release layer comprising a cross-linked polyolefin, usually it is prepared by cross-linking of the release agent comprising reactive polyolefin. The release layer formed by the above-described process has a release force of 10 to 300 mN/cm to 2 packs type acrylic adhesive.

Release agents comprising the reactive polyolefin for the cross-linking reaction are not particularly limited, as long as the reactive polyolefin comprises an ingredient which is able to chemically cross-linked said reactive polyolefin. Examples thereof may include a release agent comprising a reactive polyolefin, a multi-functional compound having not less than 2 functional groups per molecule, which are reactable with the reactive polyolefin, and a non-reactive polyolefin having a density of 0.94 g/cm³; and a release agent comprising a reactive polyolefin having 0.01 to 5% by weight of functional groups which are reactable with the multi-functional compound and also having a density of not more than 0.94 g/cm³, and a multi-functional compound which is reactable with the reactive polyolefin, having not less than 2 functional groups per molecule.

In the present invention, the reactive polyolefin forms 3-dimentional networks by gelating with cross-linkable compounds or gelating therewith. By such a cross-linking reaction, a heat and chemical resistance are provided to the release layer.

The cross-linkable compounds reactable with the reactive polyolefin means a compound which is dispersed microscopically or dissolved in the reactive polyolefin and cross-links to form networks, so that heat and chemical resistances of the release layer are improved. Of the cross-linkable compounds reactable with reactive polyolefin, preferred is a compound also having the effect to improve adhesion to release substrate by a reaction or interaction with functional groups existing the surface thereof.

In the present invention, the chemical cross-linking reaction is carried out among reactive functional groups. For example, the chemical cross-linking is formed between a reactive polyolefin having at least one functional group per molecule such as hydroxyl, amino, epoxy, acid anhydride, carboxyl or isocyanate group and a multi-functional compound having not less than 2 functional groups per molecule, which are reactable with the reactive polyolefin.

It is preferable to use the multi-functional compound reactable with the reactive polyolefin so that homogeneous gelation due to microscopical dispersion in the reactive polyolefin can be attained.

In order to consist both good release property and solvent resistance, a miscibility between the reactive polyolefin and the non-reactive polyolefin which constitute the release layer is important. When a reactive polyolefin having a low miscibility is used, the release layer has an insufficient solvent resistance and a higher release force due to the bleeding out of reactive polyolefin on the surface thereof.

The reactive polyolefin usable in the present invention are not particularly limited as long as the reactive polyolefin has reactive functional groups in the polyolefin structure. Preferred are compounds having at least one (average) functional group such as hydroxyl group, isocyanate group, amino group, epoxy group, acid anhydride group and carboxyl group in a molecule of polyolefin structure. In order to consist low release force and high adhesion against release substrate, the amount of functional groups contained in a reactive polyolefin is preferably 0.05 to 5% by weight, more preferably 0.01 to 1% by weight. When the amount of functional groups exceeds 5% by weight, the release force tends to increase.

When the reactive polyolefin is used, the excellent low release force and high adhesion to release substrate may be obtained without blending the non-reactive polyolefin. Just as low density polyethylene may reduced the influence on the release force, an excellent release layer may be obtained without using the non-reactive polyolefin in the case of using a reactive polyolefin having a density of not more than 0.94 g/cm³ and an amount of functional groups of 0.01 to 5% by weight.

Examples of reactive polyolefin may include a modified polyolefin prepared by reacting with a compound having functional groups in a state of melt or solution, and a polyolefin obtained by using co-polymerization method such as an olefin is reacted with a compound having reactivity with ethylene and the like under existence of catalysts. Preferable functional groups are epoxy group, hydroxyl group and acid anhydride group.

Examples of reactive polyolefin may include modified ethylene-α-olefin co-polymer by hydroxymethacrylate, modified polyethylene by hydroxymethacrylate, modified polyprorylene by hydroxymethacrylate, polyolefin polyol such as Polytail H or Polytail HA produced by Mitsubishi Chemical Corporation; modified ethylene-α-olefin co-polymer by maleic anhydride, modified polyethylene by maleic anhydride, modified nucleus-hydrogenated products of styrene-diene copolymers by maleic anhydride, modified polypropylene by maleic anhydride; modified ethylene-α-olefin co-polymer by methacrylate having epoxy group, modified polyethylene by methacrylate having epoxy group, modified nucleus-hydrogenated products of styrene-diene copolymers by methacrylate having epoxy group, modified polypropylene by methacrylate having epoxy group; modified ethylene-α-olefin co-polymer by methacrylate having isocyanate group (such as Karenz MOI produced by Showa Denko Co.), polyolefinpolyisocyanate (such as Mytec (registered trademark) series NY-T-36 produced by Mitsubishi Chemical Corporation); modified ethylene-α-olefin co-polymer by methacrylate having amino group, modified polyethylene by methacrylate having amino group, modified nucleus-hydrogenated products of styrene-diene copolymers by methacrylate having amino group, modified polypropylene by methacrylate having amino group.

The reactive polyolefin may have different functional groups in the molecule. Further, the reactive polyolefin used in the present invention may be a composition comprising a plurality of reactive polyolefins.

The multi-functional compounds having a functional group which is reactable with the reactive polyolefin are not particularly limited, as long as the compounds have not less than two functional groups per molecule which is reactable with the reactive polyolefin. The reactive polyolefin having reactive functional groups which are reactable with the reactive polyolefin may be used as the multi-functional compound.

Examples of a multi-functional compound may include multi-functional isocyanate such as tetramethylenediisocyanate, hexamethylenediisocyanate and their addition products, alkyldiol, polyhydric alcohol, polyethylenepolyol, polycarboxylic acid, compound having epoxy groups, polyalkyl amine and their compositions.

Preferable combinations of cross-linking reaction may include isocyanate group and amino group, isocyanate group and hydroxyl group, epoxy group and amino group, acid anhydride group and hydroxyl group, carboxyl group and amino group, acid anhydride group and hydroxyl group, epoxy group and hydroxyl group, epoxy group and amino group, or the like.

The combinations of functional groups for cross- linking reactions are preferably selected, considering reactive functional groups contained in the adhesives used for transfer coating. Namely, the deterioration of a peeling ability may occur because unreacted functional groups contained in a release layer react with functional groups contained in an adhesive layer at the transfer coating of the adhesive layer on the release layer. Therefore such reactions should be inhibited as far as possible. Unfortunately, when the interaction between an adhesive layer and a release layer exceeds the adhesion between release substrate and release layer, the adhesion properties may also deteriorate due to the migration of the release layer to the side of adhesive agent.

For example, the above-described reaction is effectively inhibited by the cross-linking reaction of a release layer with a reactive functional group having a low reactivity with reactive functional groups contained in adhesive agents. It is also effective for decrease the amount of residue of unreacted functional groups in the release layer, to properly adjust the amount of functional groups of reactive polyolefin and multi-functional compounds in release agents. Especially, it is preferable to optimize the amount of reactive functional groups contained in the reactive polyolefin and the multi-functional compound so that they are consumed perfectly by the reaction. Therefore, it is preferred to conduct such reaction that the number of each functional group should be almost the same upon the reaction between different functional groups. However, a further optimization is properly required because of the deactivation of functional groups during the coating process and the consumption of functional groups due to the reaction with the surface of a release substrate. Furthermore, the use of catalysts is effective to increase the rate of cross-linking reaction. In order to supply the field of electronic devices, the catalysts without metal elements or halogen elements are preferably selected.

According to the optimization of kinds and amounts of ingredients constituting the adhesive body of the present invention, the migration of ingredients from the release sheet to the adhesive layer may be inhibited. By this, the adhesive layer may be simply and certainly peeled from the release sheet.

In the present invention, a non-reactive polyolefin may include in the release layer. The non-reactive polyolefin may be a composition of two or more different polyolefins. In view of releasability and heat resistance, olefin elastomer having crystalline segments and polyethylene or polypropylene is preferred.

Examples of polyolefin elastomer may include ethylene-based copolymers such as ethylene-propylene copolymer, ethylene-butene copolymer, ethylene-octene copolymer and ethylene-propylene-ethylidene norbornene, nucleus-hydrogenated styrene-butadiene block copolymers, and nucleus-hydrogenated styrene-isoprene copolymers. Especially, ethylene-propylene copolymer is preferred. A release sheet having especially excellent releasability can be obtained by using ethylene-propylene as a main component.

In case of use of polyethylene, polyethylene synthesized by using transition metal catalyst such as Ziegler-Natta catalysts and metallocene catalysts is preferred. Especially, a release sheet having both excellent releasability and heat resistance can be obtained by using the polyethylene synthesized by metallocene catalysts. Examples of polyethylene may include ethylene-α-olefin copolymers such as ethylene-propylene copolymer, ethylene-hexene copolymer, ethylene-butene copolymer and ethylene-octene copolymer.

In case of use of polypropylene, polypropylene copolymer which comprises propylene unit as a main component, is dissolved at room temperature and has the molecular weight of not less than 10,000 is preferred.

Although the density of non-reactive polyolefin is not particularly limited, it is preferably not more than 0.94 g/cm³, more preferably 0.92 g/cm³. Usually, the density of non-reactive polyolefin is not less than 0.86 g/cm³. When the density of non-reactive polyolefin exceeds 0.94 g/cm³, the release sheet tends to show insufficient releasability.

The release layer may include antioxidants, antistatic agents, anti-blocking agents, paraffin, paraffin wax, polypropylene and polyethylene, if required.

The methods for providing a release layer on a release substrate are not particularly limited. Examples may include hot melting, coating method, co-extrusion method, or the like. In the case of coating methods, example may include a method in which a coating solution is applied outside of the production line of the release substrate (off-line coating) using reverse roll-coater, gravure coater, rod-coater, air doctor coater and other than coating machines above-described, which are referred in “Coating Methods” written by Yuji Harasaki and published by Maki Shoten (1979), and a method in which a coating solution is applied inside of the production line (in-line coating). In the case of coating methods, usually, the solution of release agent is prepared by dissolving a reactive agent comprising reactive polyolefin into organic solvent and the resultant solution is applied on the release substrate, thereafter the release layer is processed by cross-linking reaction. In this case, the cross-linking reaction should be carried out below the heat resistance temperature of the release substrate. The cross-linking reaction may be carried out after extrusion of a melted release layer onto a release substrate. The thickness of release layer is not particularly limited but preferably 0.03 to 5 μm. When the thickness is less than 0.03 μm, the release force tends to increase because the release layer cannot cover asperities of the surface of the release substrate. When the thickness exceed 5 μm, the rate of cross-linking reaction decreases in view of thermal conductivity, so that the adhesion between the release substrate and the release layer tend to decrease. The thickness of the release layer is preferably 0.03 to 3 μm, more preferably 0.03 to 1 μm.

The release force of a release layer comprising the release sheet of the present invention to 2 packs type acryl-based adhesive agent is 10 to 300 mN/cm, preferably 10 to 150 mN/cm, more preferably 10 to 150 mN/cm. The release force is evaluated by the method described later in Examples.

The second aspect of the present invention is an adhesive body applied an adhesive layer on the release layer of the above described release sheet.

Herein after, the adhesive body will be illustrated. The adhesive body comprises a release sheet, an adhesive layer adjacent to a release layer of the release sheet and an adhesive substrate adjacent to the adhesive layer.

The adhesive substrate is not particularly limited as long as the adhesive can adhere thereto and is the product comprising metal, plastic and rubber such as film or sheet- like electronics parts. Examples of preferable substrate may include polyester film such as poly(ethylene terephthalate) film, poly(butylene terephthalate) film, polyolefin film such as polypropylene film and poly(methylpentene) film, plastic film such as polycarbonate film, metal film such as aluminum and stainless steel and substrates comprising papers such as glassine paper, woodfree paper, coated paper, impregnated paper and synthetic paper.

The surface of these adhesive substrates may be subjected to surface treatments, if required.

Adhesive agents constituting above described adhesive layers are not particularly limited. Examples may include various adhesive agents such as rubber-based and acryl-based adhesive agents. Adhesive tapes for electronic equipments are required to have a low out-gas property and a reliable bonding property. Therefore, in the adhesive tapes, there are preferably used acryl-based adhesive agents.

The acryl-based adhesive agents may be prepared by using an acryl-based polymer obtained by an ordinary polymerization method such as a solution polymerization method, an emulsion polymerization method and an ultraviolet radiation polymerization method as a main component, and adding thereto, if required, various additives such as cross-linking agents, tackifiers, softening agents, anti-aging agents and fillers.

Examples of the acryl-based adhesive agents may include copolymers of a mixture of monomers containing, as a main component, alkyl methacrylate whose alkyl group has preferably about 2 to 12 carbon atoms, more preferably about 4 to 10 carbon atoms such as ethyl methacrylate, butyl methacrylate, isoamyl methacrylate, n-hexyl methacrylate, 2-ethylhexyl methacrylate, isooctyl methacrylate, isononyl methacrylate, decyl methacrylate and dodecyl methacrylate, and further, if required, a modifying monomer copolymerizable with the alkyl methacrylate, for example, hydroxyl group-containing monomers such as hydroxyalkyl methacrylate; cyano group-containing monomers such as acrylonitrile; amide group-containing monomers such as acryl amide and substituted acryl amides; vinyl esters such as vinyl acetate and aromatic vinyl compounds such as styrene.

According to the required stickiness, the thickness of the adhesive layer may be properly selected. Example of the range of thickness is 5 to 100 μm, preferably 20 to 50 μm.

Solvents for the solution of adhesive agents are not particularly limited. Example may include ordinary solvent such as toluene, alcohol, ethyl acetate, methyl ethyl ketone, mixture thereof and water.

Solution of adhesive agents is prepared by adding adhesive agents to the above-described solvent. Cross-linking agents and cross-linking assist agents may admix if required. The solid content of the solution of adhesive agents is usually 10 to 90% by weight.

When providing the adhesive layer on the release layer, transfer coating may be used, which transfer coating comprises laminating the adhesive substrate on the release layer of the release sheet after directly applying the solution containing adhesive agents and drying. The adhesive layer may be laminated with the release layer of the release sheet after applying an adhesive agent on the adhesive substrate using ordinary coating methods and drying.

In the present invention, the preparation method of the adhesive layer on the release layer and the adhesive substrate is not particularly limited. When coating methods are adopted, examples of method may include to apply coating solution outside of the production line of an adhesive substrate (off-line coating) using reverse roll-coater, gravure coater, rod-coater, air doctor coater, which are referred in “Coating Methods” written by Yuji Harasaki and published by Maki Shoten (1979) or other than coating machines above-described and to apply coating solution inside thereof (in-line coating).

Upon the production process of adhesive bodies, the adhesive layer may be formed by applying the solution of adhesive agents on the release layer of the release sheet using transfer coating. Actually, the adhesive body may be formed by laminating the adhesive substrate on the adhesive layer obtaining by the process. Another adhesive body may be prepared by winding itself to serve as the release substrate and the adhesive substrate after forming the adhesive layer on the release layer. This adhesive body may easily peel at the surface of the adhesive layer and the release layer.

### EXAMPLES

From the following description, the features of the present invention will be more concretely explained by examples and comparative examples. The parameter of the examples such as materials, amounts of use, compositions, process details and process manuals may be changed without departing from the scope of the present invention if required. It is therefore to be understood that the embodiments of the present invention should not serve to limit the scope of the present invention. Materials used in examples and comparative examples are listed below.

[Release Substrate]

Release substrate 1: Biaxially oriented poly(ethylene terephthalate) film having 40 μm thick

Release substrate 2: Oriented polypropylene film having 40 μm thick

[Non-reactive Polyolefin]

Ethylene-propylene copolymer 1: Shown by Production Example 1.

Ethylene-propylene copolymer 2: Shown by Production Example 2.

Ethylene-hexene copolymer 1: Shown by Production Example 3.

Ethylene-hexene copolymer 2: Shown by Production Example 4.

[Reactive Polyolefin]

Modified ethylene-propylene copolymer with hydroxylethyl methacrylate shown by Production Example 5.

Modified ethylene-hexene copolymer with hydroxyl ethylmethacrylate shown by Production Example 6. “Polytail H” produced by Mitsubishi Chemical Corporation. (Hydrogenated polybutadiene having OH group, number average molecular weight: 2700, OH group amount obtained by NMR: 1.5% by weight, density: 0.85 g/cm³)

[Three Functional Isocyanate]

“Mytecs 718A” produced by Mitsubishi Chemical Corporation.

A triol addition product of aliphatic three functional isocyanate (a 76% by weight of butyl acetate solution)

[Adhesive Substrate]

Polyester film “DIAFOIL T100-38” produced by Mitsubishi Polyester Film Corporation (thickness of 38 μm)

[2 Packs Type Acryl-Based Adhesive Agent Solution]

“SK-Dyne 1604N” produced by Soken Chemical & Engineering Co., Ltd. (Acryl-based ester copolymer compound (CAS.No.25119-83-9), adhesive agent solution of mixture of toluene and ethyl acetate (35:25) dissolving solid content of 40% by weight as adhesive agent).

[Isocyanate-Based Hardening Agent]

“Hardening agent L-45” produced by Soken Chemical & Engineering Co.,Ltd. (45% of addition product of toluene diisocyanate-trimethylol propane, 40% of toluene, 15% of ethyl acetate)

### Production Example 1

### Production of ethylene-propylene copolymer 1

A 1 L pressure polymerization vessel was purged with a mixed gas comprising ethylene and propylene at a partial pressure ratio of 8:2, and then charged with 450 mL of deaerated and dried toluene. Then, a toluene solution of methyl alumoxane containing 100 millimol of Al, which was produced by Witco Co., Ltd., was charged into the reaction system, and the resultant mixture was stirred at 70° C. for 10 min. Thereafter, 0.1 millimol of a metallocene catalyst (dimethylsilylenebis(cyclopentadienyl)zirconium dichloride) was added into the polymerization vessel, and the contents of the polymerization vessel were polymerized for 1 hour while pressurizing and maintaining an inside of the polymerization vessel at 0.7 MPa with the mixed gas of ethylene and propylene to obtain ethylene-propylene random copolymer. As a result of the ¹H-NMR analysis, the molar ratio of ethylene to propylene in the obtained product was 74:26. MFR was 2.0 g/10 min. Density was 0.86 g/cm³.

### Production Example 2

### Production of ethylene-propylene copolymer 2

A 1 L pressure polymerization vessel was purged with a mixed gas comprising ethylene and propylene at a partial pressure ratio of 6:4, and then charged with 450 mL of deaerated and dried toluene. Then, a toluene solution of methyl alumoxane containing 100 millimol of Al, which was produced by Witco Co., Ltd., was charged into the reaction system, and the resultant mixture was stirred at 70° C. for 10 min. Thereafter, 0.1 millimol of a metallocene catalyst (dimethylsilylenebis(cyclopentadienyl)zirconium dichloride) was added into the polymerization vessel, and the contents of the polymerization vessel were polymerized for 1 hour while pressurizing and maintaining an inside of the polymerization vessel at 0.7 MPa with the mixed gas of ethylene and propylene to obtain ethylene-propylene random copolymer. As a result of the H-NMR analysis, the molar ratio of ethylene to propylene in the obtained product was 51:49. MFR was 2.0 g/10 min. Density was 0.86 g/cm³.

### Production Example 3

### Production of ethylene-hexene copolymer 1

A 1 L pressure polymerization vessel was purged with ethylene gas, and then charged with 450 mL of toluene and 25 g of 1-hexene both deaerated and dried. Then, a toluene solution of methyl alumoxane containing 100 millimol of Al, which was produced by Witco Co., Ltd., was charged into the reaction system, and the resultant mixture was stirred at 70° C. for 10 min. Thereafter, 0.1 millimol of a metallocene catalyst (dimethylsilylenebis(cyclopentadienyl)zirconium dichloride) was added into the polymerization vessel, and the contents of the polymerization vessel were polymerized for 2 hours while pressurizing and maintaining an inside of the polymerization vessel at 0.5 MPa with ethylene gas to obtain ethylene-hexene random copolymer. As a result of the ¹H-NMR analysis, the molar ratio ethylene to propylene of the obtained product was 76:24. MFR was 3.5 g/10 min.

### Production Example 4

### Production of ethylene-hexene copolymer 2

A 1 L pressure polymerization vessel was purged with ethylene gas, and then charged with 450 mL of toluene and 16 g of 1-hexene both deaerated and dried. Then, a toluene solution of methyl alumoxane containing 100 millimol of Al, which was produced by Witco Co., Ltd., was charged into the reaction system, and the resultant mixture was stirred at 70° C. for 10 min. Thereafter, 0.1 millimol of a metallocene catalyst (dimethylsilylenebis(1-indenyl)zirconium dichloride) was added into the polymerization vessel, and the contents of the polymerization vessel were polymerized for 2 hours while pressurizing and maintaining an inside of the polymerization vessel at 0.5 MPa with ethylene gas to obtain ethylene-hexene random copolymer was obtained. As a result of the 1H-NMR analysis, the molar ratio ethylene to propylene of the obtained product was 85:15. MFR was 17 g/10 min.

### Production Example 5

### Production of modified ethylene-propylene copolymer with hydroxyethyl methacrylate

100 parts of the ethylene-propylene copolymer produced in Production Example 1, 30 parts of hydroxybutyl acrylate, and 6.6 parts of dimethyl peroxide were weighed and dissolved in orthodichlorobenzene to obtain 2.0% solution. The solution was reacted at 150° C. for 7 hours. The mixture of reactants was poured into methanol, then filtered and dried to obtain modified polyolefin. As a result of the NMR analysis, the content of hydroxybutyl acrylate was 0.32% by weight and the amount of OH group was 0.04% by weight. Density was 0.86 g/cm³.

### Production Example 6

### Production of modified ethylene-hexene copolymer with hydroxyethyl methacrylate

A modified polyolefin was obtained as in Production example 5 except that ethylene-hexene copolymer 1 obtained in Production example 3 was used instead of ethylene-propylene copolymer 1.

As a result of the NMR analysis, the amount of OH group was 0.04% by weight. Density was 0.88 g/cm³.

In the description of the present invention, the amounts of functional group were determined from the spectra of ¹H-NMR. Spectra of ¹H-NMR were measured using GSX 400 manufactured by JEOL. Specimens were prepared by dissolving in dichlorobenzene as solvent and measured in a 2 to 10% by weight solution. Measurement conditions were as follows: 400 MHz as Resonance frequency, 45 degree as pulse angle, 20 second as pulse width, 3000 to 4000 times as SCANS, −1 to 15 ppm as observation range.

### Example 1

The ethylene-propylene copolymer obtained in Production Example 1 (75 parts by weight) and the ethylene-hexene copolymer obtained in Production Example 3 (25 parts by weight)were blended to prepare a non-reactive polyolefin having density of 0.865 g/cm³. 99.5 parts by weight of the prepared non-reactive polyolefin and 0.5 parts by weight of polyolefinpolyol were mixed and heated with toluene to obtain a 2% concentration of toluene solution. Three functional isocyanate was added to the toluene solution in such amount that the amount of isocyanate group was 1.1 equivalent to the amount of OH group contained in the non-reactive polyolefin, and also one part by weight of 1,4-diazabicyclo[2,2,2]octane was added based on 100 parts by weight of total solid amount of non-reactive polyolefin and reactive polyolefin to obtain a release agent solution. The release agent solution was applied on a release substrate 1 (A-4 size) using a bar coater and dried for 3 minutes in a dryer (“Safeven Dryer N50-S5” manufactured by Satake Chemical Equipment Mfg., Ltd.) heated to 150° C., thereby obtaining a release sheet having a 0.2 μm thickness of a release layer.

A 1.5 parts by weight of an isocyanate-based hardening agent was added to a 100 parts by weight of solution of a 2 packs type acryl-based adhesive agent, and then the mixture thereof was stirred to obtain a homogeneous solution. The mixed solution was applied on the release layer of the release sheet to form a 100 μm thickness and 8 cm width of the adhesive agent solution using an applicator (Manufactured by Tayu Kizai Co., Ltd, for 100 μm use) at 23° C. After 2 seconds from the application, the release sheet was dried for 2 minutes in a dryer (“Safeven Dryer N50-S5” manufactured by Satake Chemical Equipment Mfg., Ltd.) at 100° C., and taken out from the dryer to cool till room temperature. The resultant thickness of the adhesive layer was 40 μm. After 2 minutes from the cooling to room temperature, an adhesive substrate was set on the adhesive layer and pressed using a to-and-fro run of 2kg of roller with a 30 cm/min of running speed, thereby obtaining an adhesive body applied the adhesive sheet on the release sheet.

### Example 2

The ethylene-propylene copolymer obtained in Production Example 1 (25 parts by weight) and the ethylene-hexene copolymer obtained in Production Example 4 (75 parts by weight) were blended to prepare, a non-reactive polyolefin having a density of 0.89 g/cm³. 99 parts by weight of non-reactive polyolefin and 1 part by weight of polyolefinpolyol were mixed and dissolved in toluene under heating, to obtain a 2% concentration of toluene solution. Three functional isocyanate was added to the toluene solution in such amount that the amount of isocyanate group was equal equivalent to the amount of OH group contained in the non-reactive polyolefin, and also one part by weight of 1,4-diazabicyclo[2,2,2]octane was added based on 100 parts by weight of total solid amount of non-reactive polyolefin and reactive polyolefin to obtain a release agent solution. The release agent solution was applied on the release substrate 1 (A-4 size) using the bar coater and dried in the dryer (“Safeven Dryer N50-S5” manufactured by Satake Chemical Equipment Mfg., Ltd.) heated to 150° C. for 3 minutes, thereby obtaining a release sheet having 0.2 μm thickness of a release layer.

An adhesive layer was formed on the release sheet by the same manner as defined in Example 1, and an adhesive substrate was laminated thereon, thereby obtaining an adhesive body.

### Example 3

The modified ethylene-propylene copolymer with hydroxyethyl methacrylate obtained in Production Example 5 (50 parts by weight) and the modified ethylene-hexene copolymer with hydroxyethyl methacrylate obtained in Production Example 6 (50 parts by weight) were blended to prepare, a reactive polyolefin having density of 0.87 g/cm³. The reactive polyolefin was dissolved in toluene under heating, thereby obtaining a 2% concentration of toluene solution. Three functional isocyanate was added to the toluene solution in such a manner that the amount of isocyanate group was equal equivalent to the amount of OH group contained in the reactive polyolefin, and also one part by weight of 1,4-diazabicyclo[2,2,2]octane was added based on 100 parts by weight of solid reactive polyolefin to obtain a release agent solution. The release agent solution was applied onto the release substrate 1 (A-4 size) using the bar coater and dried for 3 minutes in the dryer (“Safeven Dryer N50-S5” manufactured by Satake Chemical Equipment Mfg., Ltd.) heated to 150° C., thereby obtaining release sheet having 0.3 μm thickness of a release layer.

An adhesive layer was formed on the release sheet by the same manner as defined in Example 1, and an adhesive substrate was laminated thereon, thereby obtaining an adhesive body.

### Example 4

The same procedure as defined in Example 2 was conducted except that the release substrate 1 was replaced to a release substrate 2 and the drying temperature of forming a release layer was replaced to 100° C., thereby obtaining a release sheet.

An adhesive layer was formed on the release sheet by the same manner as defined in Example 1, and an adhesive substrate was laminated thereon, thereby obtaining an adhesive body.

### Comparative Example 1

The ethylene-propylene copolymer 2 obtained in Production Example 2 (74 parts by weight) and the ethylene-hexene copolymer obtained in Production Example 3 (26 parts by weight) were blended to prepare a non-reactive polyolefin having a density of 0.865 g/cm³. The non-reactive polyolefin was dissolved in toluene, thereby obtaining a toluene solution containing 2% by weight of a release agent. The release agent solution was applied onto the release substrate 1 (A-4 size) using the bar coater and dried for 3 minutes in the dryer (“Safeven Dryer N50-S5” manufactured by Satake Chemical Equipment Mfg., Ltd.) heated to 150° C., thereby obtaining release sheet having 0.2 μm thickness of a release layer.

An adhesive layer was formed on the release sheet by the same manner as defined in Example 1, and an adhesive substrate was laminated thereon, thereby obtaining an adhesive body.

### Comparative Example 2

A non-silicone based release agent obtained by mofifying polyvinyl alcohol with long chain alkyl isocyanate (“Peeloil 1050” produced by Ipposha Oil Industries Co., Ltd.) was applied onto the release substrate 1 using the bar coater and dried for 3 minutes in the dryer (“Safeven Dryer N50-S5” manufactured by Satake Chemical Equipment Mfg., Ltd.) heated to 150° C., thereby obtaining release sheet having 1 μm thickness of a release layer.

An adhesive layer was formed on the release sheet by the same manner as defined in Example 1, and an adhesive substrate was laminated thereon, thereby obtaining an adhesive body.

### Testing Example

After the release sheets and adhesive bodies obtained in each of above Examples and Comparative Examples were aged for 72 hours at room temperature (23° C.), these were measured for the following items.

[Release Force at Ordinary State]

The release sheet was cut into a tape having a 25 mm width and a 150 mm long, and a release force was measured according to JIS Z-0237. Namely, the adhesive agent side of an adhesive tape (“Nitto Tape No.502” produced by Nitto Denko Corporation) having a 25 mm width was laminated on the release layer of the release sheet and pressed using a to-and-fro run of 2 kg of rubber roller. Thereafter, the release sheet was fixed on a tensile test machine and the release force of 180 degree direction was measured using a tensile test machine under a 300 mm/minute elongation speed at 25° C., then the results were normalized by the width of release sheet. A release force at ordinary state was determined by the average value of 8 specimens under the same measurement condition.

[Release Force to 2 Packs Type acryl-based Adhesive Agent]

A adhesive sheet was cut into a tape having a 25 mm width and a 150 mm long, and a release force was measured according to JIS Z-0237. Namely, after 1 hour aging, the tape was peeled off to 180 degree direction at a 300 mm/min of peeling speed by a tensile test machine, then average load for peeling was measured within a stable region of peeling. The measured average peeling load divided by the width of tape was assigned to the release force. A release force against 2 packs type acryl-based adhesive agent was determined by the average value of 8 specimens under the same measurement condition.

[Adhesion Between Release Layer and Release Substrate]

The adhesive agent side of an cellophane adhesive tape (“Product Number T-SS24N” produced by KOKUYO Co., Ltd.) having a 25 mm width and a 60 mm long was laminated on the release layer of release sheet and pressed using a to-and-fro run of 2 kg of roller, thereby stabilizing after 72 hours aging. The prepared tape was fixed and peeled off to 180 degree direction under a 300 mm/min of peeling speed. Thereafter, the release layer remained on the surface of the release substrate was observed by a microscope. The results were classified to the following three levels.
A: a release layer was perfectly remained on a substrate.
B: a release layer was peeled off sparsely.

C: a release layer was perfectly peeled off from a release substrate so that the release layer was perfectly migrated to the adhesive layer side of the adhesive tape. These results are summarized in Table 1.

TABLE 1

| | | | Adhesion |
|---|---|---|---|
| | Release force | | between |
| | towards 2 packs | Release force | release layer |
| | type acryl-based | at ordinary | and release |
| | resin (mN/cm) | state (mN/cm) | substrate |
| Example 1 | 150 | 55 | A |
| Example 2 | 170 | 60 | A |
| Example 3 | 150 | 100 | A |
| Example 4 | 170 | 80 | A |
| Comp. | 350 | 170 | C |
| Example 1 | | | |
| Comp. | 3200 | 105 | A |
| Example 2 | | | |

As seen from Table 1, the release sheets of the present invention have an excellent release force at ordinary state and adhesion between the release layer and the release substrate, and also have a low release force at ordinary state and after transfer coating. On the other hand, the release sheets of Comparative example 1 and 2 have a high release force and have an inferior adhesion between the release layer and the release substrate.

### INDUSTRIAL APPLICABILITY

According to the present invention, the release sheet and adhesive body having an excellent heat resistance, solvent resistance and adhesion between the release layer and the release substrate, and capability of direct transfer coating of an adhesive layer on a release layer, are provided.

What is claimed is:

1. A release sheet comprising a release substrate and a release layer which comprises cross-linked polyolefin, is formed one at least one side of said release substrate, and has from 10 to 300 mN/cm of release force to an adhesive layer formed from a 2 packs type acryl-based adhesive agent.

2. A release sheet according to claim 1, wherein said release layer comprises a reactive polyolefin, a multi-functional compound having not less than 2 functional groups per molecule reactable with said reactive polyolefin and a non-reactive polyolefin having a density of not more than 0.94 g/cm³.

3. A release sheet according to claim 2, wherein said reactive polyolefin has functional groups reactable with said multi-functional compound in an amount of 0.01 to 5% by weight.

4. A release sheet according to claim 1, wherein said release layer comprises a reactive polyolefin having functional groups reactable with said multi-functional compound in an amount of 0.01 to 5% by weight of and a multi-functional compound having not less than 2 functional groups per molecule reactable with said reactive polyolefin.

5. A release sheet according to any of claim 2, wherein said functional groups of said reactive polyolefin and said multi-functional compound is any of the functional groups selected from the group consisting of epoxy, hydroxyl, acid anhydride, isocyanate and amino group independently; and said cross-linking reaction occurs among said functional groups.

6. A release sheet according to any of claim 1, wherein the thickness of release layer is 0.03 to 5 μm.

7. A release sheet according to any of claim 1, wherein said release layer is formed by dissolving said reactive polyolefin in organic solvent to prepare a solution, applying said solution on a release substrate and cross-linking said reactive polyolefin.

8. A release sheet according to claim 1, wherein the release substrate is a resin film or a paper.

9. A resin sheet according to claim 8, wherein the release substrate is a polyester film.

10. A resin film according to claim 8, wherein the release substrate is a polyolefin film.

11. An adhesive body comprising an adhesive layer formed on said release layer of said release sheet as defined in claim 1.

12. An adhesive body according to claim 11, wherein said adhesive layer is formed by transfer coating of said solution containing an adhesive agent.
